(19) United States
(12) Patent Application Publication
(10) Pub. No.: US 2026/0257661 A1
(43) Pub. Date: Sep. 3, 2026

(54) Method for Operating a Hybrid Vehicle, and Hybrid Vehicle

(71) Applicant: Bayerische Motoren Werke Aktiengesellschaft, Muenchen (DE)

(72) Inventors: Oiher ASPE, Muenchen (DE); Patrick SCHAEDLER, Muenchen (DE)

(21) Appl. No.: 19/162,118

(22) PCT Filed: Mar. 19, 2024
(86) PCT No.: PCT/EP2024/057337

§ 371 Date: Sep. 4, 2025

(30) Foreign Application Priority Data
Apr. 20, 2023 (DE) 10 2023 110 062.9

(51) Int. Cl. B60W 20/10; B60W 10/06; B60W 10/08

(52) U.S. Cl. CPC B60W 20/10; B60W 10/06; B60W 10/08; B60W 2520/10; B60W 2710/06; B60W 2710/08; B60W 2720/106; B60W 2720/30

(57) ABSTRACT

A method for operating a hybrid vehicle comprising an input device for a wheel torque and comprising a main drive with an electric motor and with an internal combustion engine. The internal combustion engine is additionally used if a wheel torque specified by way of the input device is greater than a maximum wheel torque that can be achieved by way of the electric motor, and if an achieved acceleration is less than a minimum acceleration.

### BACKGROUND AND SUMMARY

This disclosure relates to a method for operating a hybrid vehicle and a hybrid vehicle. The hybrid vehicle comprises a main drive having an electric motor and an internal combustion engine.

Motor vehicles, such as passenger vehicles, comprise a main drive for the propulsion. This comprises a motor, by way of which a torque is provided, which is conducted to one or more wheels of the motor vehicle so that an acceleration of the motor vehicle takes place. An input device, such as an accelerator pedal, is typically provided for the control of the main drive. The main drive is actuated depending on its actuation by the driver, so that the motor vehicle is moved in a desired manner.

For example, the main drive solely comprises an engine, which is designed, for example, as an internal combustion engine. In order to be able to drive locally without emissions at least sometimes, the main drive increasingly comprises an electric motor, which is operated by way of a corresponding energy storage device, such as a high-voltage battery. In order that a weight and costs of the energy storage device are not too high and a sufficient range of the motor vehicle is possible without recharging the energy storage device, the main drive comprises both an electric motor and an internal combustion engine. The motor vehicle is thus designed as a so-called hybrid vehicle. Depending on the current requirements, one of the two or both motors are operated, thus used, so that one or more wheels of the motor vehicle are driven thereby.

An operating mode is typically provided in such a hybrid vehicle, in which only the electric motor is used for the propulsion, whereas the internal combustion engine is shut down. In other words, in this operating mode the hybrid vehicle is only moved by way of electrical energy, so that it is moved locally without emissions. During recharging of the energy storage device, it is possible here to only use regenerative energy sources, because of which fossil energy carriers can be dispensed with during operation of the motor vehicle. Since the internal combustion engine is not used, however, the dynamism and the maximum torque in this operating mode are reduced, thus in particular the acceleration and also the maximum achievable velocity of the vehicle.

It is possible in this case that a current actuation of the accelerator pedal corresponds to a greater dynamism, such as a higher acceleration, than can be implemented by way of the electric motor alone. The actuation can also correspond to a compensation for an excessive velocity loss due to an increased travel resistance, such as during an uphill climb, wherein this cannot be achieved solely by way of the electric motor. If the internal combustion engine is not additionally used now, the actuation of the accelerator pedal by the driver, thus the intention of the driver, will not be corresponded to, which, on the one hand, can anger the driver. On the other hand, it is possible that a hazardous traffic situation arises, for example, because the driver cannot move the motor vehicle sufficiently quickly out of a hazard zone.

Alternatively thereto, it is possible upon such an actuation of the foot pedal to change the operating mode and also use the internal combustion engine, so that an increased acceleration can be implemented. However, if the torque corresponding to the actuation of the accelerator pedal is only slightly greater than the torque that can be provided by way of the electric motor, the changed dynamism resulting due to the additional use of the internal combustion engine is not essentially not perceptible to the driver. However, the intention of the driver to move forward solely by way of operation of the electric motor will not be complied with, so that there is an annoyance for them and therefore a level of comfort is reduced.

The disclosure is based on an object of specifying a particularly suitable method for operating a hybrid vehicle and a particularly suitable hybrid vehicle, wherein advantageously a level of comfort is increased for a user.

The method is used to operate a hybrid vehicle. The hybrid vehicle is a motor vehicle which is in particular land-based and is preferably designed as multitrack. It is suitably possible in this case to position the hybrid vehicle, which is also referred to hereinafter as a motor vehicle, substantially freely, in particular on a roadway. The hybrid vehicle expediently comprises corresponding wheels for this purpose. In summary, it is preferably possible to position the hybrid vehicle on land essentially independently of other conditions. In other words, the hybrid vehicle is suitably not rail-guided. The hybrid vehicle is preferably a passenger vehicle or a utility vehicle, such as a truck or bus.

The hybrid vehicle comprises a main drive. In particular, one or more wheels of the hybrid vehicle are driven here by way of the main drive, which are expediently mounted by way of a chassis or the like on a body of the hybrid vehicle. All wheels or only a part of the wheels are driven here by way of the main drive, for example. Further components, such as a drivetrain, which comprises a transmission, for example, are expediently mechanically arranged between the main drive and any wheels, so that a drive of the wheels takes place via the drivetrain.

The hybrid vehicle furthermore comprises an input device for a wheel torque. The input device is expediently arranged in this case inside an interior of the hybrid vehicle and is expediently positioned such that it can be operated by a driver of the hybrid vehicle. It is therefore possible for the driver to specify a desired wheel torque. The input device is, for example, a hand lever, a keypad, or particularly preferably an accelerator pedal, in particular a foot pedal, which is also referred to as a so-called “gas pedal”.

By way of the input device, it is possible in this case to specify a wheel torque, thus, for example, the wheel torque directly or a variable corresponding thereto. The wheel torque is expediently a torque in this case and in particular corresponds to the torque which is applied by way of the possible wheel or wheels to a road or the like. The wheel torque preferably corresponds in this case to a torque provided by way of the main drive. In other words, there is a functional relationship between them, wherein the relationship is in particular determined on the basis of the possible drivetrain. In particular a setpoint value is specified here by way of the input device, preferably a setpoint wheel torque, and the main drive is suitably operated according to the specified wheel torque, for example, regulated or controlled.

The main drive comprises an internal combustion engine, which operates, for example, according to the diesel principle or the gasoline principle. During operation, the internal combustion engine acts on one or more wheels, which are therefore mechanically driven by way of the internal combustion engine, in particular via the possible drivetrain. Moreover, the main drive comprises an electric motor, which is, for example, a brushless DC motor. For example, the electric motor acts during operation on one or all wheels on which the complete main drive acts. The two motors are designed and arranged such that each of them can act mechanically on one or more wheels of the motor vehicle. In other words, it is a parallel hybrid system.

In one refinement, the main drive comprises multiple electric motors, wherein these are expediently assigned to different wheels. The motor vehicle suitably comprises an energy storage device, such as a battery, in particular a high-voltage battery, by way of which the electric motor is energized. In particular an electrical voltage above 100 V or 300 V is provided during operation by way of the energy storage device. The electrical voltage is preferably equal to 400 V. An inverter is expediently connected in this case between the energy storage device and the electric motor. In particular, it is possible to charge the energy storage device by way of an external voltage source, such as a charging column. The motor vehicle is therefore expediently a so-called plug-in hybrid vehicle.

The method provides that a wheel torque specified by way of the input device is checked. If it is greater than a maximum wheel torque implementable by way of the electric motor, it is furthermore checked as an additional condition whether an implemented acceleration is less than a minimum acceleration. In this case, the internal combustion engine is additionally used, or at least a required condition for the use of the internal combustion engine is met. In other words, it is necessary for at least the implemented acceleration to be less than a minimum acceleration. However, it is also possible that the internal combustion engine is first used when still another condition is met.

In summary, in particular solely, in this case the internal combustion engine is additionally used to drive the hybrid vehicle, which up to this point was expediently stationary, for which, for example, the internal combustion engine is started and/or engaged. The internal combustion engine is therefore only additionally used if (at least) the described conditions are met. In summary, the internal combustion engine is therefore additionally used in the method if the wheel torque specified by way of the input device is greater than the maximum wheel torque implementable by way of the electric motor, and if an implemented acceleration is less than a minimum acceleration.

The maximum wheel torque implementable by way of the electric motor is, for example, constant and/or permanently specified. However, it is particularly preferably always newly determined in each case. In particular, current restrictions or power losses are taken into consideration here, for example, due to heating of the electric motor or the possible energy storage device. In other words, in the method, the respective current maximum implementable wheel torque of the electric motor is therefore determined. The current maximum implementable wheel torque is specified in this case, for example, on the basis of a current state of the electric motor and/or a current state of the energy storage device.

To determine the implemented acceleration, which in particular can also be designated as the ACTUAL acceleration, for example, a corresponding acceleration sensor is used and therefore the acceleration is directly measured. Alternatively thereto, the acceleration is determined by way of a time derivative of the implemented velocity. No additional sensor is therefore necessary, because of which production costs are reduced. In particular, the ACTUAL acceleration is therefore an implemented acceleration which is measured by way of at least one sensor, thus in particular at least one sensor measured value or a variable determined on the basis of at least one sensor measured value.

In particular, the method is therefore solely carried out if the internal combustion engine is not being used, thus in particular is stationary. For example, the method is always carried out here or is particularly preferably only carried out in a specific operating mode, thus when the hybrid vehicle is in the specific operating mode. The operating mode in particular corresponds here to a setting in which only the electric motor is to be used, in particular only with the described exception. For example, the method is only carried out, thus the presence of the conditions is checked, if the motor vehicle is already in motion and, for example, has a specific minimum velocity. Alternatively, the method is also carried out when the hybrid vehicle is at a standstill.

It is therefore ensured in the method that the internal combustion engine is started when the hybrid vehicle is to be moved comparatively quickly, wherein up to this point only the electric motor has been used for the propulsion. In contrast, even if increased dynamism is desired on the part of the user, which is set on the basis of the corresponding operation of the input device, but at least a sufficient acceleration is implemented, the internal combustion engine is not used, so that the hybrid vehicle is only driven by way of the electric motor. It is therefore possible to operate the hybrid vehicle using at least a specific dynamism, wherein an excessive use of the internal combustion engine is avoided, in particular if the method is only carried out in the specific operating mode. One of the intentions of the user of the motor vehicle is therefore taken into consideration, namely the selection of the specific operating mode, wherein it is nonetheless ensured that if needed an increased acceleration is implemented, which is greater than the acceleration implementable solely by way of the electric motor.

For example, the internal combustion engine is used if at one time the implemented acceleration is less than the minimum acceleration when simultaneously or within a specific time window the wheel torque specified by way of the input device is greater than the maximum wheel torque implementable by way of the electric motor.

However, the internal combustion engine is particularly preferably only additionally used if a time integral over a function is greater than a first limiting value. The starting point for the integral is in particular the point in time from which the implemented acceleration is less than the minimum acceleration, and/or from which the wheel torque specified by way of the input device is greater than the maximum wheel torque implementable by way of the electric motor. It is therefore not only checked once whether the implemented acceleration is less than the minimum acceleration, but rather for a specific time span, wherein this is specified on the basis of the function and the first limiting value. The function and the first limiting value are preferably designed here such that the time span is between 2 seconds and 100 seconds. It is therefore ensured due to the use of the time span that in the event of an inadvertent, short-term operation of the input device, the internal combustion engine is not unintentionally started. In particular, the internal combustion engine is therefore used if the specified wheel torque is greater than the maximum implementable wheel torque and at the same time the implemented acceleration is less than the minimum acceleration over the time span.

Preferably, as soon as the implemented acceleration is less than the minimum acceleration, the integral is continuously prepared. In other words, the individual function values are in particular summed from this point in time to prepare the integral. If the integral exceeds the first limiting value, in particular the internal combustion engine is used here, or this is at least used as a corresponding condition which results in the use of the internal combustion engine.

For example, the function is constant in this case, so that the internal combustion engine is always used if the implemented acceleration for the time span is less than the minimum acceleration, wherein the length of the time span is constant and corresponds to the first limiting value. It is necessary here for the implemented acceleration to be less than the minimum acceleration during the complete time span. If the implemented acceleration is greater than the minimum acceleration, in particular the time span is ended and is only restarted the next time the implemented acceleration is less than the minimum acceleration, and when the wheel torque specified by way of the input device is greater than the maximum wheel torque implementable by way of the electric motor.

Alternatively thereto, for example, the value of the integral is set to zero and, for example, the integral is subsequently refilled. In a further alternative, the value of the integral is reduced, preferably by a further value, which is constant, for example. Preferably, as long as the implemented acceleration is greater than the minimum acceleration, a negative constant value is used for the function.

For example, the first limiting value is constant or variable, in particular depending on specific specifications. The first limiting value is expediently selected depending on a deviation between the implemented acceleration and the minimum acceleration. It is therefore possible to ensure that with a comparatively large deviation, the time span is comparatively short, so that an adaptation of the dynamism of the hybrid vehicle takes place early.

However, the function is particularly preferably dependent on the deviation between the implemented acceleration and the minimum acceleration. The value of the function is expediently greater here if the deviation between the implemented acceleration and the minimum acceleration is also greater. For example, the function is steady and/or differentiable. Alternatively thereto, the function has, for example, kinks or jumps. In particular, the function is biunique, or the same function value is assigned to different deviations. For example, the function is specified analytically or particularly preferably on the basis of a characteristic map, wherein the individual values of the characteristic map are expediently specified depending on a desired behavior of the hybrid vehicle. The behavior is adapted here, for example, to the respective hybrid vehicle and/or an equipment line of the hybrid vehicle.

For example, the deviation between the implemented acceleration and the minimum acceleration is used directly as a function, in particular the absolute value. Alternatively thereto, in particular a direct proportionality is present between these or particularly preferably a disproportionality, so that the function value is greater the greater the deviation is. It is therefore ensured that in the event of a severe undershoot, the internal combustion engine is used comparatively quickly.

For example, the function is only dependent on the deviation. However, the function is particularly preferably also dependent on a current velocity, thus the velocity at which the hybrid vehicle is currently moved. If the characteristic map is used, it is therefore in particular two-dimensional. The values of the function are expediently reduced here with increasing velocity.

For example, the minimum acceleration is constant. However, the minimum acceleration is particularly preferably selected depending on the current velocity. In particular, the minimum acceleration is less here the greater the current velocity is. For example, the dependence is analytically specified or stored in a characteristic map. For example, the dependence is steady and/or differentiable. Alternatively thereto, jumps or kinks are present. The same minimum acceleration is preferably assigned here in each case to at least some velocities. In particular, at the point in time, moreover the wheel torque specified by way of the input device becomes greater than the maximum wheel torque implementable by way of the electric motor, thus when this is exceeded, the current velocity is determined and the minimum acceleration corresponding thereto. This is subsequently used in the comparison of the implemented acceleration with the minimum acceleration. For example, this is used here in the determination of the integral, or the minimum acceleration is always determined again during the preparation of the integral, when the function value is also determined again.

For example, the internal combustion engine is used as soon as the wheel torque specified by way of the input device is less than the maximum wheel torque implementable by way of the electric motor, and if the implemented acceleration is greater than the minimum acceleration or if the integral is greater than the first limiting value. However, it is particularly preferably checked whether a further condition is met. In other words, the internal combustion engine is therefore only additionally used if the further condition is met. It is therefore possible to handle special driving situations and to avoid excessive use of the internal combustion engine, in particular if this is not desired or absolutely necessary.

For example, it is checked for this purpose whether the currently specified wheel torque is greater than a second limiting value. In particular, in this case the currently specified wheel torque is used, which is changed, for example, in comparison to the wheel torque which was present at the point in time at which the wheel torque specified by way of the input device was first greater than the maximum wheel torque implementable by way of the electric motor, and/or when the implemented acceleration was first less than a minimum acceleration. Alternatively, the wheel torque specified at the point in time is used if all other conditions are met, thus in particular if the possible integral is greater than the first limiting value. In summary, the specified wheel torque is checked absolutely and compared to the second limiting value. The internal combustion engine is therefore only activated if a comparatively high wheel torque is actually desired, and not solely upon a comparatively inadvertent actuation of the input device.

For example, the second limiting value is constant. However, the second limiting value is particularly preferably selected such that it corresponds to a predetermined setting of the input device. In other words, the second limiting value is therefore selected, for example, depending on a current velocity of the hybrid vehicle, an operating mode, and/or an actuation of the main drive. The second limiting value is therefore in particular dependent on specific parameters of the hybrid vehicle, which are time-dependent, for example. The setting of the input device, in contrast, is in particular constant or, for example, dependent on a current velocity and/or an operating mode. It is therefore comprehensible for the user of the hybrid vehicle when the further condition is met, because of which a level of acceptance is increased.

If the input device is an accelerator pedal, the second limiting value in particular corresponds to a specific setting of the accelerator pedal. In particular, the second limiting value corresponds to an actuation of the accelerator pedal by at least 75% or 80% and/or expediently by less than 95% or 90%. The second limiting value expediently corresponds to an actuation of 85%. Therefore, the internal combustion engine is only used when the accelerator pedal is pressed comparatively strongly, thus when the intention of the driver for a strong acceleration exists comparatively reliably.

Alternatively or in combination therewith, the condition is met if, from the point in time from which the implemented acceleration is less than the minimum acceleration, the specified wheel torque was increased by more than a third limiting value. In other words, if the implemented acceleration is less than the minimum acceleration/the integral is greater than the first limiting value, it is furthermore checked whether a setting of the input device was changed further. Therefore, after it has been established that the implemented acceleration is less than the minimum acceleration, and that the wheel torque specified by way of the input device is greater than the maximum wheel torque implementable by way of the electric motor, the actuation of the input device is also furthermore checked. If the integral is used, in particular the change of the specified wheel torque with respect to the wheel torque specified at the point in time is used, at which the integral has reached the first limiting value. The user of the hybrid vehicle only performs a corresponding actuation of the input device if a higher acceleration or the like is desired and this is comparatively urgent, for example, due to a current driving situation. An inadvertent use of the internal combustion engine is therefore essentially precluded.

For example, the third limiting value is constant. However, the third limiting value is particularly preferably selected such that it corresponds to a predetermined change of the setting of the input device. This in particular corresponds to the actuation of the possible accelerator pedal by a value between 20% and 40%, for example, 30%. In particular, the condition is therefore met if the angle position of the accelerator pedal was changed by more than 30% of the maximum adjustment angle, and/or if the accelerator pedal was moved by 30% of the length of the maximum adjustment travel. The predetermined change is expediently always constant here, so that the corresponding actuation of the input device is always comprehensible for the user of the hybrid vehicle, such as the driver. It is therefore possible for this driver to cause a start of the internal combustion engine if needed without a change of an operating mode being required.

The hybrid vehicle is a motor vehicle and, for example, is land-based and is, for example, a truck, bus, or preferably a passenger vehicle. The hybrid vehicle comprises a main drive having an electric motor and an internal combustion engine. One or more wheels of the hybrid vehicle are expediently driven here by way of the main drive. A drivetrain is suitably mechanically arranged for this purpose between the main drive and the wheels. For example, the same wheels are driven by way of the electric motor and the internal combustion engine, or at least some or all of the respectively driven wheels differ. An energy storage device, such as a battery, is expediently present to energize the electric motor. It is preferably possible in this case to also charge this by way of an external power source. The hybrid vehicle is therefore a so-called plug-in hybrid vehicle.

The hybrid vehicle furthermore comprises an input device for a wheel torque. It is in particular possible here to specify the wheel torque by way of the input device, on the basis of which in particular a regulation and/or control of the main drive takes place. The input device is expediently arranged in an interior of the hybrid vehicle, so that this can be actuated by a user of the hybrid vehicle, preferably by the driver.

The hybrid vehicle is operated according to a method in which the internal combustion engine is additionally used if a wheel torque specified by way of the input device is greater than a maximum wheel torque implementable by way of the electric motor, and if an implemented acceleration is less than a minimum acceleration. In this case, before the use of the internal combustion engine, it is expediently stationary, and/or the method is carried out, for example, when the hybrid vehicle is in a specific operating mode.

The hybrid vehicle in particular comprises a control unit, which is intended and configured to carry out the method. The control unit comprises, for example, an application-specific integrated circuit (ASIC) or particularly preferably a computer, which is suitably designed as programmable. In particular, the control unit comprises a storage medium, on which a computer program product, which is also referred to as a computer program, is stored, wherein when this computer program product, thus the program, is executed, the computer is caused to carry out the method. The control unit is expediently formed at least partially by way of an onboard computer of the hybrid vehicle. The disclosure furthermore relates to such a control unit.

The disclosure furthermore relates to a computer program product. The computer program product comprises a number of commands which, when the program (computer program product) is executed by a computer, cause it to carry out the method. The computer is expediently a component part of a control unit or electronics unit and, for example, is formed by way of this. The computer preferably comprises a microprocessor or is formed by way of this. The computer program product is, for example, a file or a data carrier which contains an executable program, which automatically carries out the method upon an installation on a computer.

The disclosure furthermore relates to a storage medium, on which the computer program product is stored. Such a storage medium is, for example, a CD-ROM, a DVD, or a Blu-ray disc. Alternatively thereto, the storage medium is a USB stick or another memory, which is, for example, rewritable or is only writable once. Such a memory is, for example, a flash memory, a RAM, or a ROM.

The refinements and advantages explained in conjunction with the method are also to be transferred correspondingly to the hybrid vehicle/the computer program product/the storage medium/the control unit and among one another and vice versa.

An exemplary embodiment of the disclosure is explained in more detail hereinafter on the basis of a drawing. In the figures:

### BRIEF DESCRIPTION OF THE DRAWINGS

FIG. 1 schematically shows a hybrid vehicle in a side view,

FIG. 2 shows a method for operating the hybrid vehicle, and

FIG. 3 shows two different minimum accelerations.

### DETAILED DESCRIPTION OF THE DRAWINGS

Parts corresponding to one another are provided with the same reference signs in all figures.

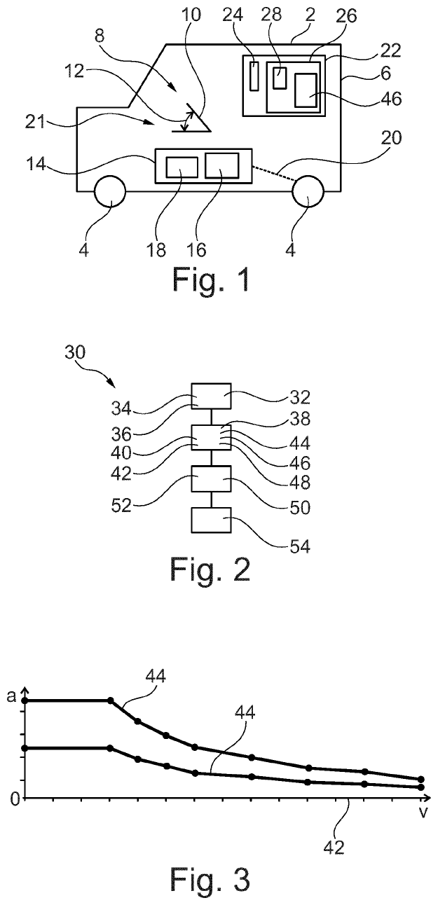

A hybrid vehicle 2, namely a passenger vehicle, is shown in schematically simplified form in FIG. 1. The hybrid vehicle 2, which is also referred to solely as a motor vehicle, comprises four wheels 4, which stand on a roadway (not shown in more detail). The wheels 4 are mounted by way of a chassis on a body 6 of the hybrid vehicle 2, by way of which an interior 8 is enclosed. An input device 10 is arranged in the interior 8, namely a foot pedal, the setting of which can be changed. A position is changed for this purpose, for which an angle position 12 is changed. The input device 10 is arranged such that it can be operated by a driver of the hybrid vehicle 2 by way of their foot.

The hybrid vehicle 2 furthermore comprises a main drive 14, which comprises an internal combustion engine 16 and an electric motor 18. A maximum power applicable by way of the electric motor 18 is greater than 100 kW here, but less than 800 kW, and the maximum power applicable by way of the internal combustion engine 16 is also greater than 100 KW and, for example, less than 800 kW. The internal combustion engine 16 operates here, for example, according to the gasoline principle, and the electric motor 18 is a brushless DC motor. A tank (not shown in more detail), which can be filled with a fuel, is provided for the operation of the internal combustion engine 16. An energy storage device (not shown in more detail), which can be charged by way of an external power source, such as a charging column, is provided for energizing the electric motor 18. The hybrid vehicle 2 is therefore a plug-in hybrid vehicle.

The main drive 14 has a mechanical connection to at least some of the wheels 4 via a drivetrain 20. The drivetrain 20 comprises a transmission (not shown in more detail) and a differential in this case. For example, the same wheels 4 are driven via the drivetrain 20 by way of the internal combustion engine 16 and the electric motor 18, or the two motors 16, 18 are assigned to different wheels 4. However, it is at least possible to use either only the internal combustion engine 16 or the electric motor 18 or also both motors 16, 18 in order to drive the corresponding wheels 4, so that a forward movement of the motor vehicle 2 takes place.

In operation, a wheel torque 21 is specified by the user here by way of the input device 10, namely in that the angle position 12 is changed. The main drive 14 is set on the basis of the specified wheel torque 21, and at least one of the two motors 16, 18 is operated accordingly for this purpose, so that a torque is provided. This torque acts on the wheels 4 via the drivetrain 20. The wheel torque 21 is functionally related to the torque provided by way of the main drive 14, wherein the relationship is specified on the basis of the mechanical design of the drivetrain 20.

The hybrid vehicle 2 furthermore comprises a control unit 22, which comprises a computer 24 in the form of a programmable microprocessor. The control unit 22 also comprises a storage medium in the form of a memory 26, on which a computer program product 28 is stored. The computer program product 28 comprises a number of commands here, which, when the computer program 28 is executed by the computer 24, cause it to carry out a method 30 shown in FIG. 2. The hybrid vehicle 2 is therefore operated according to the method 30, and the control unit 22 is intended and configured to carry out the method 30.

The method 30 is started with a first work step 32. The first work step 32 is carried out here when a specific operating mode 34 is activated by the driver of the hybrid vehicle 2. The operating mode 34 corresponds to a setting, in which only the electric motor 18 is to be used for the propulsion of the hybrid vehicle 2. The selection of this operating mode 34 is in particular only possible here if the energy storage device (not shown in more detail) has a minimum state of charge and/or the hybrid vehicle 2 is not moved at ultrahigh velocity.

In the first work step 34, the internal combustion engine 16 is shut down and only the electric motor 18 is operated, thus used, in order to drive the corresponding wheels 4. If an operation of the input device 10 is carried out by the user and therefore the wheel torque 21 is specified, an energization of the electric motor 18 is adapted accordingly. Moreover, a maximum wheel torque 36 implementable by way of the electric motor 18 is continuously determined. This is specified on the basis of the mechanical and the electrical design of the electric motor 18 and of the energy storage device. However, it is possible in this case that the maximum wheel torque 36 implementable by way of the electric motor 18, which is also referred to solely as the maximum implementable wheel torque 36, is reduced due to a current operating situation, for example, in the event of excessive heating of the electric motor 18 or the energy storage device.

If the wheel torque 21 specified by way of the input device 10 is greater than the maximum wheel torque 36 implementable by way of the electric motor 18, for example, due to heating of the energy storage device and/or the electric motor 18, a second work step 38 is carried out. In this step, an implemented acceleration 40 is determined, for which a time derivative of a current velocity 42 of the hybrid vehicle 2 is prepared. The current velocity 42 is already used here to carry out further driving functions, so that no additional work effort is necessary for this purpose.

A minimum acceleration 44, which is specified on the part of the producer of the hybrid vehicle 2, is determined on the basis of the current velocity. The minimum acceleration 44 is dependent on the current velocity 42. Two different such minimum accelerations 44 are shown in FIG. 3, one of which is used. The minimum acceleration 44 is constant up to a threshold at a low current velocity 42, and decreases with increasing current velocity 42. In summary, the minimum acceleration 44, which is selected depending on the current velocity 42, is therefore determined in the second work step 38.

As soon as the minimum acceleration 44 has been determined, it is compared with the implemented acceleration 40. If the implemented acceleration 40 is greater than the minimum acceleration 44, the second work step 44 is ended and the first work step 32 is carried out again. Otherwise, a time integral is prepared over a function 46. The function 46 is stored here in the memory 26 and corresponds to a characteristic map. In other words, the function 46 is not an analytical function, but rather an assignment takes place in accordance with a fixed specification.

The function 46 is dependent on the deviation between the implemented acceleration 40 and the minimum acceleration 44. The function 46 is also dependent on the current velocity 42. The value of the function 46 is all the greater here the greater the deviation is between the implemented acceleration 40 and the minimum acceleration 44. The value of the function 46 is also greater the less the current velocity 42 is. The value of the function 46 is determined accordingly for successive points in time, and the integral is prepared in each case, thus essentially continuously, on the basis thereof. If the integral exceeds a first limiting value 48, the preparation of the integral is ended and a third work step 50 is carried out. However, if, while the integral is still being determined, the implemented acceleration 40 is greater than the minimum acceleration 44, thus before the first limiting value 48 is reached, the first work step 32 is carried out again. The third work step 50 is therefore only carried out if, since the start of the second work step 38, the implemented acceleration 40 is continuously less than the minimum acceleration 44. Alternatively, the value of the integral is reduced by a specific value with each new point in time.

In the third work step 50, it is checked whether the wheel torque 21 specified then, thus at the point in time of exceeding the first limiting value 48, meets a further condition 52, that can be different from the wheel torque 21 specified during the second work step 38.

For this purpose, the angle position 21 of the input device 10, on the basis of which the current wheel torque is specified, is checked and compared with a predetermined setting of the input device 10. An actuation of the input device 10 by 85% is used as the predetermined setting of the input device 10. Such a setting of the angle position 21 of the input device 10 corresponds here to a specific wheel torque, namely a (respective) second limiting value, so that therefore the specified wheel torque 21 is compared with the second limiting value. The further condition 52 is met in this case if the specified wheel torque 21 is greater than the second limiting value, thus the input device 10 is actuated by more than 85%. In summary, the second limiting value is selected such that it corresponds to a predetermined setting of the input device 10, independently of other parameters of the hybrid vehicle 2.

The further condition 52 is also met if the angle position 12 of the input device 10 was changed by more than 30% since the start of the second work step 38, wherein the wheel torque 21 was increased. The further condition 52 is therefore met if, since the point in time from which the implemented acceleration 40 is less than the minimum acceleration 44, the specified wheel torque 21 was increased by more than a third limiting value. The third limiting value is selected here such that it corresponds to a predetermined change of the setting of the input device 10.

It is therefore possible to meet the further condition 52 in two different ways, wherein a corresponding actuation of the input device 10 by the driver of the hybrid vehicle 2 is required in each case for this purpose. If the further condition 52 is also met, a fourth work step 54 is carried out. In this step, the internal combustion engine 16 is started and used for the drive of the corresponding wheels 4.

The internal combustion engine 16 is therefore used in spite of the selection of the specific operating mode 34, wherein this only takes place if the wheel torque 21 specified by way of the input device 10 is greater than the maximum wheel torque 36 implementable by way of the electric motor 18. It is necessary here for the time integral over the function 46 to be greater than the first limiting value 48. The start of the internal combustion engine 16 also only takes place if the currently specified wheel torque 21 meets the further condition 52.

Due to the additional use of the internal combustion engine 16, it is not necessary for the driver of the hybrid vehicle 2 to end the operating mode 34 manually, wherein nonetheless in specific driving situations, in which the maximum wheel torque 36 implementable by way of the electric motor 18 is not sufficient to provide the minimum acceleration 44, the hybrid vehicle 2 can be moved with comparatively high dynamism.

The disclosure is not restricted to the above-described exemplary embodiments. Rather, other variants of the disclosure can also be derived therefrom by a person skilled in the art without departing from the subject matter of the disclosure. In particular, furthermore all individual features described in conjunction with the exemplary embodiment are also combinable with one another in other ways without departing from the subject matter of the disclosure.

List of reference signs

| | |
|---|---|
| 2 | hybrid vehicle |
| 4 | wheel |
| 6 | body |
| 8 | interior |
| 10 | input device |
| 12 | angle position |
| 14 | main drive |
| 16 | internal combustion engine |
| 18 | electric motor |
| 20 | drivetrain |
| 21 | wheel torque |
| 22 | control unit |
| 24 | computer |
| 26 | memory |
| 28 | computer program product |
| 30 | method |
| 32 | first work step |
| 34 | operating mode |
| 36 | maximum implementable wheel torque |
| 38 | second work step |
| 40 | implemented acceleration |
| 42 | current velocity |
| 44 | minimum acceleration |
| 46 | function |
| 48 | first limiting value |
| 50 | third work step |
| 52 | further condition |
| 54 | fourth work step |
| a | acceleration |
| v | velocity |

1.-10. (canceled)

11. A method for operating a hybrid vehicle having an input device for a wheel torque and a main drive having an electric motor and an internal combustion engine, the method comprising:
using the internal combustion engine in addition to the electric motor if a wheel torque specified by way of the input device is greater than a maximum wheel torque implementable by way of the electric motor, and if an implemented acceleration is less than a minimum acceleration.

12. The method according to claim 11, wherein
the internal combustion engine is only additionally used if a time integral over a function, which is dependent on the deviation between the implemented acceleration and the minimum acceleration, is greater than a first limiting value.

13. The method according to claim 12, wherein
the function is also selected depending on a current velocity.

14. The method according to claim 11, wherein
the minimum acceleration is selected depending on a current velocity.

15. The method according to claim 11, wherein
the internal combustion engine is only additionally used if the currently specified wheel torque meets a further condition.

16. The method according to claim 15, wherein
the further condition is met if the specified wheel torque is greater than a second limiting value.

17. The method according to claim 16, wherein
the second limiting value is selected such that it corresponds to a predetermined setting of the input device.

18. The method according to claim 15, wherein
the further condition is met if, since the point in time from which the implemented acceleration is less than the minimum acceleration, the specified wheel torque was increased by more than a third limiting value.

19. The method according to claim 18, wherein
the third limiting value is selected such that it corresponds to a predetermined change of the setting of the input device.

20. A hybrid vehicle comprising an input device for a wheel torque and a main drive having an electric motor and an internal combustion engine, and which is operated according to a method according to claim 11.
